(19) United States
(12) Patent Application Publication
(10) Pub. No.: US 2017/0188259 A1
(43) Pub. Date: Jun. 29, 2017

(54) DISTRIBUTING L2 BUFFER STATUS INFORMATION IN 5G MULTI-CONNECTIVITY FOR EFFICIENT RADIO SCHEDULING

(71) Applicant: Nokia Technologies Oy, Espoo (FI)

(72) Inventors: Vinh Van Phan, Oulu (FI); Ling YU, Kauniainen (FI); Timo KOSKELA, Oulu (FI); Samuli TURTINEN, Ii (FI); Subramanya CHANDRASHEKAR, Bangalore (IN); Andreas MAEDER, Wurzburg (DE)

(21) Appl. No.: 15/384,847

(22) Filed: Dec. 20, 2016

(30) Foreign Application Priority Data
Dec. 28, 2015 (IN) 7009/CHE/2015

(51) Int. Cl. H04W 28/02; H04W 72/04; H04W 72/12

(52) U.S. Cl. CPC H04W 28/0278; H04W 72/1252; H04W 72/0486

(57) ABSTRACT

Various communication systems may benefit from having appropriate information regarding communication resources. For example, systems implementing fifth generation multi-connectivity may be able to provide efficient radio scheduling through distribution of L2 buffer status information. A method can include preparing, by a multi-connectivity aggregating entity, an aggregated buffer status regarding a plurality of legs of a split radio access flow. The method can also include distributing the aggregated buffer status to a plurality of schedulers of the legs.

### BACKGROUND

Field

Various communication systems may benefit from having appropriate information regarding communication resources. For example, systems implementing fifth generation (5G) multi-connectivity may be able to provide efficient radio scheduling through distribution of L2 buffer status information. Even though the invention is described in the context of 5G systems, it may also be employed in other wireless cellular systems such as Long Term Evolution (LTE), Wideband Code Division Multiple Access (WCDMA), and CDMA2000, for example. In addition to different wireless cellular systems, the invention may be employed in several other wireless systems, such as, Wireless Local Area Network (WLAN), and Worldwide Interoperability for Microwave Access (WiMAX) systems as well.

Description of the Related Art

In wireless systems, there may be multi-connectivity (MC). In MC, an active user equipment (UE) in MC may be served by at least two Node Bs (NBs), base stations or access points in general, and the established L2 entities, at least the higher layer protocols of RAN i.e. RRC and NCS, of the UE in the network side may be centralized in a master NB or a so-called multi-node controller (MNC). The MNC can connect and control a number of NBs and can provide an NCS anchor for MC. NCS is Network Convergence Protocol, an evolution of packet data convergence protocol (PDCP) where IP, Ethernet or any other practical packet networks have convergence.

MC can involve an independent medium access control (MAC) entity and radio scheduler per each radio connection between a UE and a serving NB of MC, which can shortly be referred to as an MC leg. The MAC scheduler may schedule radio transmissions for individual UEs in both uplink (UL) and (DL) based on buffer statuses of individual UEs with respect to individual priority logical channel groups as in LTE, or priority queues in general.

L2 buffers of individual priority queues of UE in MC may be distributed in different nodes serving MC of UE in the network side. The actual L2 buffers residing in each serving NB for DL MC, corresponding to local eNB buffer after flow control taking place, may not reflect the overall global L2 buffer statuses of corresponding priority queues. Therefore, using the local status information of the actual L2 buffers may not be optimized for MAC scheduling decision in terms of priority handling among UEs served by same MAC scheduler.

In UL MC with radio bearer or radio access flow split without duplication among multiple MC legs, MAC scheduling decision based on the the buffer statuses of corresponding priority queues across involved MC legs may also not be optimized

### SUMMARY

According to certain embodiments, a method can include preparing, by a multi-connectivity aggregating entity, an aggregated buffer status regarding a plurality of legs of a split radio access flow. The method can also include distributing the aggregated buffer status to a plurality of schedulers of the involved radio legs.

In certain embodiments, a method can include determining an optimized buffer status information for a user equipment regarding a plurality of legs of a split radio access flow. The method can also include signaling the optimized buffer status information toward a plurality of access nodes corresponding respectively to the plurality of legs.

An apparatus, according to certain embodiments, can include at least one processor and at least one memory including computer program code. The at least one memory and the computer program code can be configured to, with the at least one processor, cause the apparatus at least to prepare, by a multi-connectivity aggregating entity, an aggregated buffer status regarding a plurality of legs of a split radio access flow. The at least one memory and the computer program code can also be configured to, with the at least one processor, cause the apparatus at least to distribute the aggregated buffer status to a plurality of schedulers of the legs.

An apparatus, in certain embodiments, can include at least one processor and at least one memory including computer program code. The at least one memory and the computer program code can be configured to, with the at least one processor, cause the apparatus at least to determine an optimized buffer status information for a user equipment regarding a plurality of legs of a split radio access flow. The at least one memory and the computer program code can also be configured to, with the at least one processor, cause the apparatus at least to signal the optimized buffer status information toward a plurality of access nodes corresponding respectively to the plurality of legs.

According to certain embodiments, an apparatus can include means for preparing, by a multi-connectivity aggregating entity, an aggregated buffer status regarding a plurality of legs of a split radio access flow. The apparatus can also include means for distributing the aggregated buffer status to a plurality of schedulers of the legs.

In certain embodiments, an apparatus can include means for determining an optimized buffer status information for a user equipment regarding a plurality of legs of a split radio access flow. The apparatus can also include means for signaling the optimized buffer status information toward a plurality of access nodes corresponding respectively to the plurality of legs.

A computer program product can, according to certain embodiments, encode instructions for performing a process. The process can correspond to any of the above methods.

A non-transitory computer-readable medium can, in certain embodiments, be encoded with instructions that, when executed in hardware, perform a process. The process can correspond to any of the above methods.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates another method according to certain embodiments.

FIG. 3 illustrates a system according to certain embodiments.

FIG. 4 illustrates a system architecture according to certain embodiments.

FIG. 5 illustrates an option for uplink buffer handling for multiconnectivity, according to certain embodiments.

FIG. 6 illustrates another option for uplink buffer handling for multiconnectivity, according to certain embodiments.

FIG. 7 illustrates a further option for uplink buffer handling for multiconnectivity, according to certain embodiments.

FIG. 8 illustrates an option for downlink buffer handling for multiconnectivity, according to certain embodiments.

### DETAILED DESCRIPTION

In multi-connectivity (MC), in order to facilitate optimized packet scheduling for individual MC legs involved in serving a user equipment (UE) in MC, certain embodiments may provide for smart distribution and indication of relevant L2 buffer status information among the involved MC legs for both uplink (UL) and downlink (DL). This provided L2 buffer status information may complement whatever UL medium access control (MAC) buffer status report (BSR) and any flow control between the aggregating entity and the access nodes mechanisms. Certain embodiments provide a method for distributing and signaling relevant L2 buffer status information to MAC schedulers involved in serving a UE in MC for both UL and DL.

There may be a variety of details of how distributing L2 buffer status information between MC anchor node and other NBs serving individual MC radio legs for either UL or DL may be accomplished. For examples, a radio bearer split at MeNB in LTE dual connectivity may rely on flow control information provided over X2 from SeNB. With the introduction of one or more radio legs in 5G MC to serve a split radio access flow (radio bearer), the relevance of sharing BSR information between the MAC schedulers of different radio legs gain significance.

In LTE, the UL BSR from UE towards MeNB and SeNB can be either independent or identical regarding different L2 priority queues without RB split or same L2 priority queue with RB split, as UL BSR is on the basis of 4 different prioritized logical channel groups (LCG) and not individual priority queues or RBs.

Certain embodiments provide a method of distributing and/or signaling relevant L2 buffer status information to MAC schedulers involved in serving a UE in MC so as to optimize scheduling decision and performance for both UL and DL. The method can include various aspects.

For example, the method can include node hosting NCS, anchor for MC, of a UE in DL may determine optimized L2 buffer status information on corresponding priority queue or radio access flow of the UE for each involved MC leg and distribute the determined L2 buffer status information to the corresponding MAC schedulers of the involved MC legs over the interface between the hosting/aggregating node and the corresponding access nodes (5G NBs) of the involved MC legs. The interface may be a 5G enhanced S1/X2 interface or similar interface. This interface is herein referred to as an S2 interface between the involved nodes. This determination and distribution of optimized L2 buffer status information can be designed to work on top of flow control to make MAC scheduling and flow control more efficient.

The determination may be based on the overall or global L2 buffer status and monitored radio performance. Examples of monitored radio performance can include throughput of involved MC legs per corresponding L2 priority queue.

The determined L2 buffer status information can be used by the corresponding MAC scheduler, either in combination with own or instead of the actual local L2 buffer status corresponding to the same L2 priority queue of the UE to make scheduling decision for the corresponding L2 priority queue of the UE. The determined L2 buffer status information may be in similar format to UL BSR. Alternatively, the determined L2 buffer status information may be in a different format, such as an explicit indicative amount of data to be expected from corresponding L2 buffer or a weighting-factor indication to scale with the corresponding actual local L2 buffer status at the serving 5G NB of involved MC leg.

For UL direction, the following options are possible, for example. According to a first option, a UE can be configured to report the overall L2 buffer status information of the individual L2 priority queues being served with MC. Optionally, the UE can also be configured to report UE monitored radio performance of corresponding MC legs. These reports can be provided to the node hosting NCS anchor for MC of the UE. Then, the hosting node can determine and re-distribute UL L2 buffer status information over S2, as discussed for DL above.

According to a second option, a UE is configured to determine and distribute optimized UL L2 buffer status information to corresponding serving 5G NB of involved MC leg over 5GUu. This option may reuse MAC BSR for UL or may use a new control element in addition to MAC BSR for UL.

According to a third option, the UE can be configured to send an independent or identical MAC BSR, but excluding corresponding buffers, at NCS and above on corresponding priority queue to all the serving 5G NBs of involved legs. In addition, the UE can be configured to send the overall global L2 buffer status information and monitored radio performance as in the first option described above. The NCS anchor node can then determine and distribute optimized L2 buffer status information such as some weighting-factor indication to scale with corresponding MAC BSR at a MAC scheduler as discussed above in an option for DL, for examples.

Thus, certain embodiments provide various aspects for downlink (DL) and uplink (UL). In DL, for example, the MC aggregating node/entity hosting the NCS anchor of MC can prepare an optimized L2 buffer status information with respect to each of the MC legs and can distribute the optimized L2 buffer status information to all the MAC schedulers of the MC legs;

In UL, for example, either the existing UL BSR may be extended or a new MAC and/or NCS control message in addition to UL BSR may be used for the UE to indicate an optimized L2 buffer status information to involved serving 5G NBs with respect to each of the MC legs. The optimized L2 buffer status information may be determined by the UE directly or by the MC aggregating entity in the network side based on indicated information received from the UE.

For the distribution of the DL L2 buffer status information over S2, S2 application protocol may implement an appropriate signaling procedure. Other protocols are also permitted.

For the UL direction with the three alternative options proposed above, the network may configure the UE to use any of the alternatives or some other alternative consistent with certain embodiments. The UL BSR may be extended or a new MAC Control Element (CE) and/or NCS Control-type protocol data unit (C-PDU) and user-plane (UP) signaling procedure may be introduced to incorporate and send the proposed L2 buffer status information.

For possible content or format of the proposed L2 buffer status information, the following options are possible, in addition to the options and examples already provided above.

In one option, the L2 buffer status information may indicate an implicit expectation of more data to come with respect to each of the MC legs. For example, the indications may include one or more of the following: no more or just small amount of data to come, significant enough amount of data to come, and large amount of data to come. These indications may correspond to some weighting factor to scale with an actual local buffer or reported BSR at each of the MC legs.

For a split radio bearer or radio access flow, with 1:1 mapping on a priority-queue and a logical channel, served with MC, the L2 buffer status information, as determined for each of the MC legs, may be the same or different or none for different legs.

Triggers for the L2 buffer status information distribution in MC may be periodical and/or threshold based events, similar to mechanisms used for UL BSR or DL flow control. Other triggers are also permitted.

The L2 buffer status information may be further combined with other control information, which may be used to assist in optimizing scheduling decision and radio performance. Such other control information may include, for example, application-aware indications including application type or identity, current active-inactive state, mobile battery level, expected session life-time and/or data volume, and so forth.

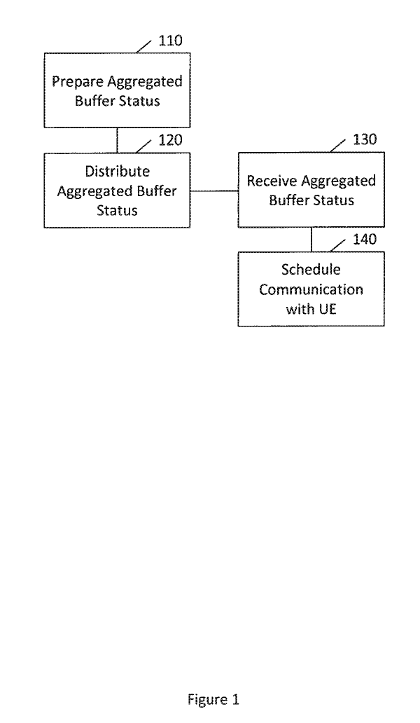

FIG. 1 illustrates a method according to certain embodiments. The method of FIG. 1 may be applicable to downlink buffer handling. As shown in FIG. 1, a method can include, at 110, preparing, by an MC aggregating entity or MC anchor node, an aggregated buffer status regarding a plurality of radio legs of a split radio access flow or radio bearer being served in MC. For example, the aggregating entity or anchor node can be an MeNB. Each of the legs can include a respective access node, with a different access node for each leg. For example, the access node can be an SeNB. For convenience, the MC aggregating entity or MC anchor node may be referred to simply by way of the example of an MC aggregating entity, but each reference should be understood to refer to either element.

Single connectivity (SC) may be considered as a special case of MC and certain embodiments may be applied for SC in case the NCS hosting or aggregating node is different from the access node which hosts the MAC scheduler and at least in part serves the radio leg of the SC. This may be the case of cloud-RAN with flexible RAN functional split.

The aggregated buffer status may be radio scheduling assistance information. For example, this may be either an explicit indicative amount of data that can be expected from a corresponding buffer of a corresponding radio bearer in MC at Application Scheduler/NCS located at the MC anchor or a weighting-factor indication to scale with the corresponding actual local L2 buffer stored at a serving 5G NB of individual involved MC leg. Alternatively, the radio scheduling assistance information may be an implicit expectation of more data to come with respect to each of the MC legs: no more or just small amount of data to come, significant enough amount of data to come, large amount of data to come (corresponding to some weighting factor to scale with the actual local buffer or reported BSR at each of the MC legs).

The method can also include, at 120, distributing the aggregated buffer status to a plurality of schedulers of the legs. The schedulers can be medium access control schedulers.

The aggregated buffer status can be configured to aggregate a plurality of L2 buffers, each respective L2 buffer corresponding to one of the plurality of legs.

The method can further include, at 130, receiving the aggregated buffer status at an access node in a leg of a split radio access flow corresponding to a user equipment. The method can also include, at 140, scheduling communication with the user equipment based on the aggregated buffer status. This may be the same aggregated buffer status sent at 120. The scheduling can also include scheduling other UEs based on knowledge about the subject UE's buffer status.

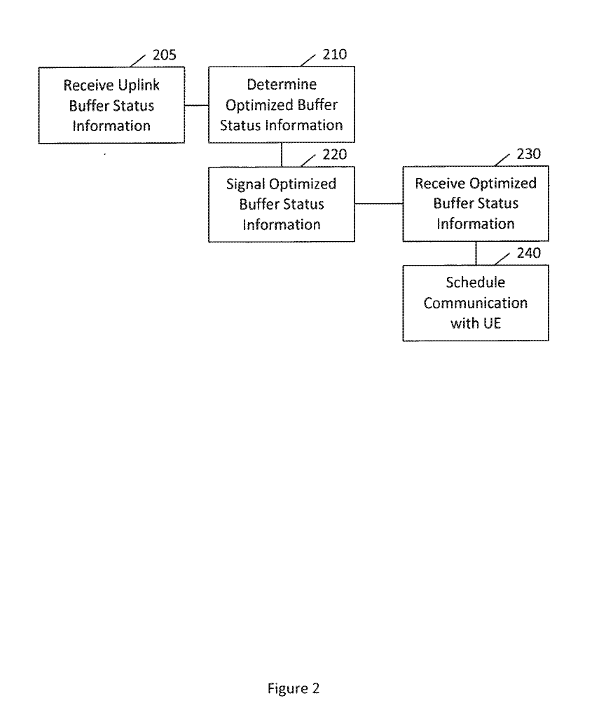

FIG. 2 illustrates another method according to certain embodiments. The method of FIG. 2 may be applicable to uplink buffer handling. As shown in FIG. 2, a method can include, at 210, determining an optimized buffer status information for a user equipment regarding a plurality of legs of a split radio access flow. The determining can be performed by the user equipment or by an aggregating entity.

The method can also include, at 220, signaling the optimized buffer status information toward a plurality of access nodes corresponding respectively to the plurality of legs. The optimized buffer status information can be signaled in at least one of a medium access control message or a NCS control message.

hi certain embodiments, such as when the determining is done by the aggregating entity, the method can include, at 205, receiving uplink buffer status information from the user equipment. In such a case, the determining the optimized buffer status information at 210 can be based on the uplink buffer status information from the user equipment.

The method can further include, at 230, receiving the optimized buffer status information at an access node in a leg of a split radio access flow corresponding to a user equipment. The method can also include, at 240, scheduling communication with the user equipment based on the optimized buffer status information. This may be the same optimized buffer status information sent at 220.

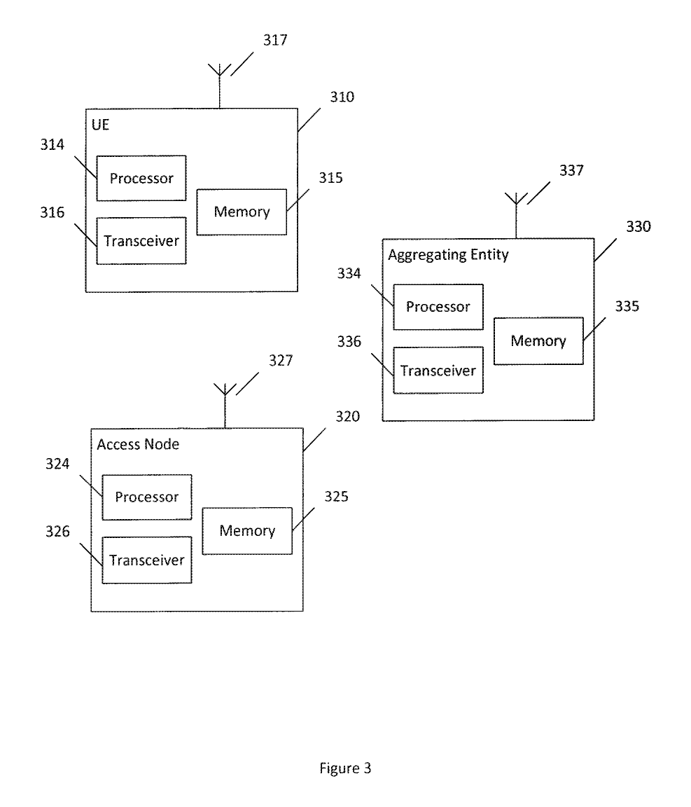

FIG. 3 illustrates a system according to certain embodiments of the invention. In one embodiment, a system may include multiple devices, such as, for example, at least one UE 310, at least one access node 320, which may be an eNB, MeNB, RNC, or other base station or access point, and at least one aggregating entity 330, which may be an eNB, SeNB, RNC, or other base station or access point, and may be configured to control multi-connectivity with respect to the access node 320. There may be multiple access nodes 320, although one is illustrated for simplicity. The aggregating entity can be a multi-connectivity anchor node.

Each of these devices may include at least one processor, respectively indicated as 314, 324, and 334. At least one memory can be provided in each device, and indicated as 315, 325, and 335, respectively. The memory may include computer program instructions or computer code contained therein. The processors 314, 324, and 334 and memories 315, 325, and 335, or a subset thereof, can be configured to provide means corresponding to the various blocks of FIGS. 1 and 2.

As shown in FIG. 3, transceivers 316, 326, and 336 can be provided, and each device may also include an antenna, respectively illustrated as 317, 327, and 337. Other configurations of these devices, for example, may be provided. For example, aggregating entity 330 may be configured for wired communication, in addition to wireless communication, and in such a case antenna 337 can illustrate any form of communication hardware, without requiring a conventional antenna.

Transceivers 316, 326, and 336 can each, independently, be a transmitter, a receiver, or both a transmitter and a receiver, or a unit or device that is configured both for transmission and reception.

Processors 314, 324, and 334 can be embodied by any computational or data processing device, such as a central processing unit (CPU), application specific integrated circuit (ASIC), or comparable device. The processors can be implemented as a single controller, or a plurality of controllers or processors.

Memories 315, 325, and 335 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 310, access node 320, and aggregating entity 330, to perform any of the processes described herein (see, for example, FIGS. 1, 2, and 5-8). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 3 illustrates a system including a UE, access node, and aggregating entity, embodiments of the invention may be applicable to other configurations, and configurations involving additional elements. For example, not shown, additional UEs may be present, additional access nodes may be present, and additional core network elements may be present.

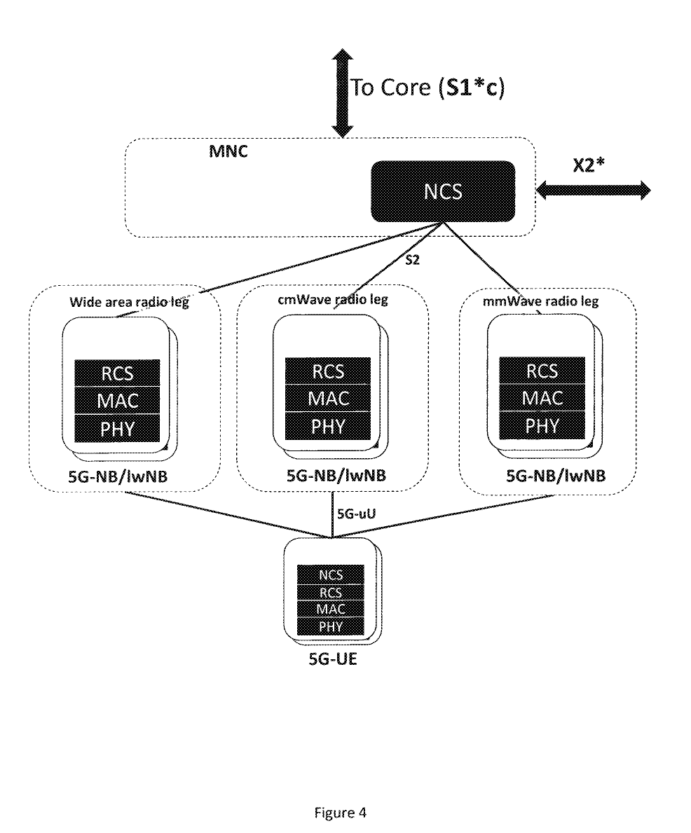

FIG. 4 illustrates a system architecture according to certain embodiments. As shown in FIG. 4, a fifth generation (5G) user equipment (UE) may be configured to use a protocol stack including NCS, RCS, MAC, and PHY layers. The 5G UE may be served by multiple connections, such as connections to one or more wide area radio leg and/or one or more cmWave radio leg. These legs may be anchored by an MNC, which may handle higher protocol layers, while the legs may deal with the lower protocol layers. The MNC may be configured to communicate with other MNCs or base stations as well as with a core network.

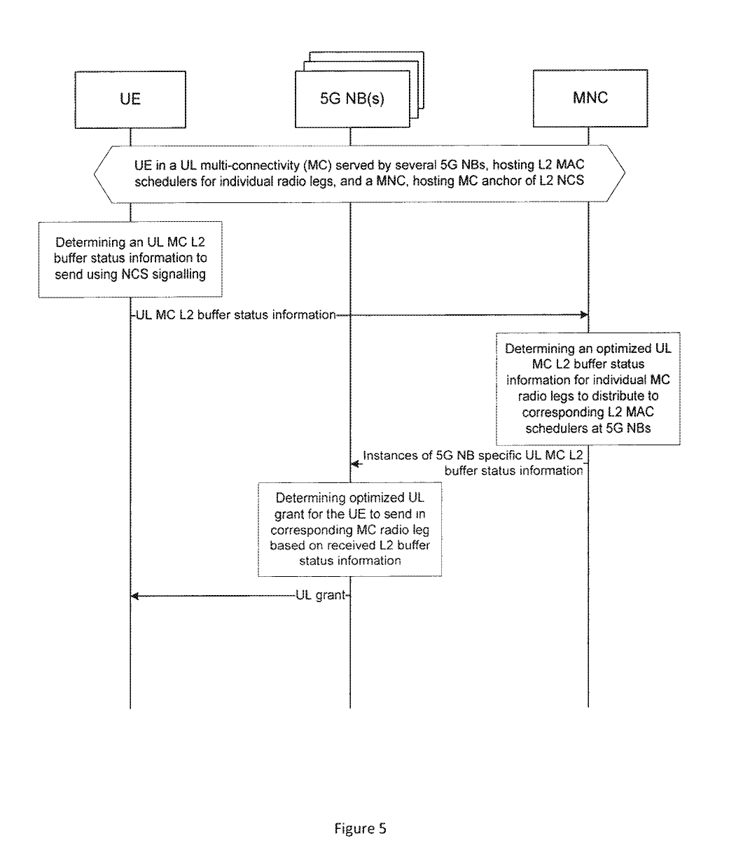

FIG. 5 illustrates an option for uplink buffer handling for multiconnectivity, according to certain embodiments. As shown in FIG. 5, a UE can be served by multiple 5G NBs, hosting L2 MAC schedulers for individual radio legs, and by a MNC, hosting an MC anchor of L2 NCS. The UE can determine an UL MC L2 buffer status information to send. The UE can send this buffer status information to the MNC via NCS signaling.

As shown in FIG. 5, the MNC can determine an optimized UL MC L2 buffer status information for individual MC radio legs to distribute to corresponding L2 MAC schedulers at 5G NBs. The MNC can then provide suitable instances of 5G NB specific UL MC L2 buffer status information to the 5G NBs. The 5G NBs can determine optimized UL grant for the UE to send in a corresponding MC radio leg based on the information received from the MNC.

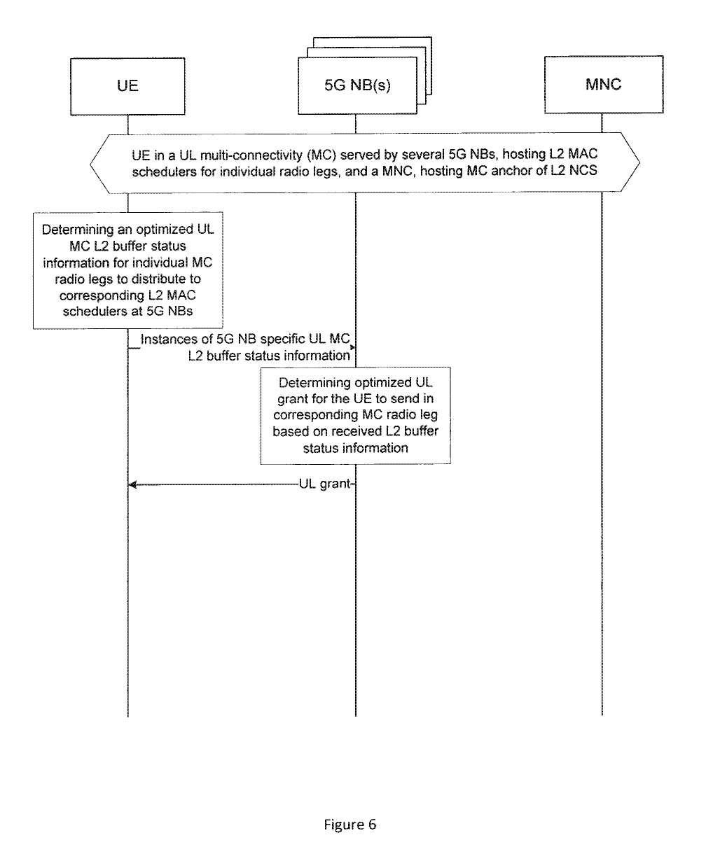

FIG. 6 illustrates another option for uplink buffer handling for multiconnectivity, according to certain embodiments. In this case, the UE may determine the optimized UL MC L2 buffer status information itself. Accordingly, the UE may provide the suitable instances of 5G NB specific UL MC L2 buffer status information to the 5G NBs. The 5G NBs can then operate as in the option shown in FIG. 5.

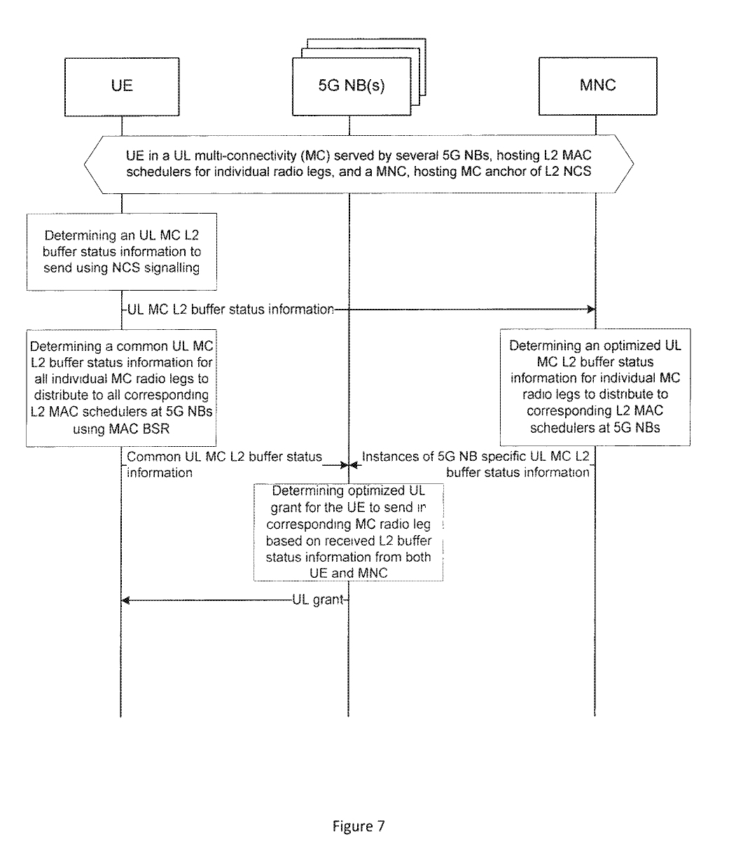

FIG. 7 illustrates a further option for uplink buffer handling for multiconnectivity, according to certain embodiments. The option shown in FIG. 7 is similar to the option shown in FIG. 5, except that in the option of FIG. 7 the UE can further determine a common UL MC L2 buffer status information and can distribute it to all legs. The NBs of the various legs can then determine an optimized UL grant combining the information received from the UE with the information received from the MNC.

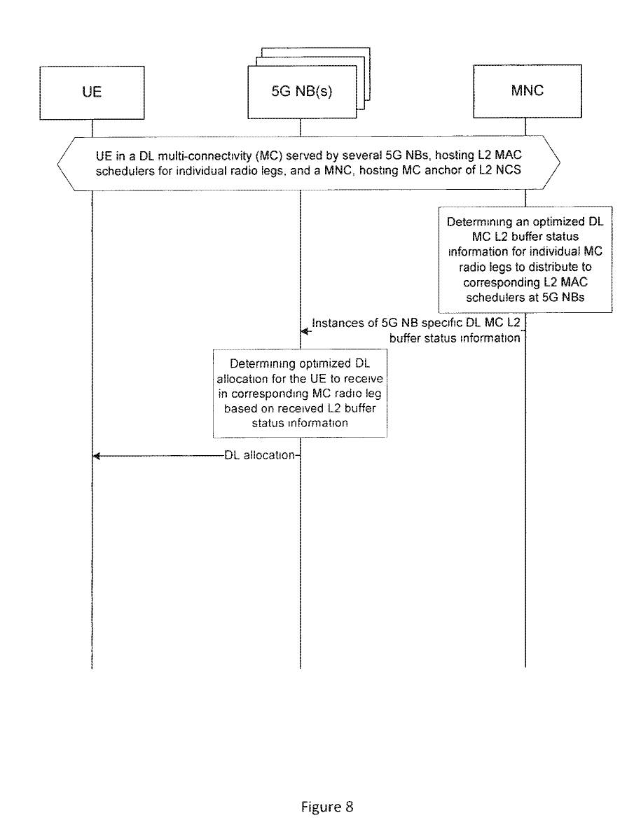

FIG. 8 illustrates an option for downlink buffer handling for multiconnectivity, according to certain embodiments. As shown in FIG. 8, a UE may be in DL multi-connectivity (MC) served by several 5G NBs, hosting L2 MAC schedulers for individual radio legs, and by an MNC hosting an MC anchor of L2 NCS. The MNC can determine an optimized DL MC L2 buffer status information for individual MC radio legs. The MNC can then provide suitable instances of 5G NB specific DL MC L2 buffer status information to the 5G NBs. The 5G NBs can determine optimized DL allocation for the UE to receive in a corresponding MC radio leg based on the information received from the MNC.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

In an exemplary embodiment, an apparatus may include means for carrying out embodiments described above and any combination thereof.

In an exemplary embodiment, a computer-readable medium encoded with instructions that, when executed by a computer, cause performance of a method according to embodiments described above and any combination thereof.

We claim:

1. A multi-connectivity anchor node, comprising:
at least one processor; and
at least one memory including computer program code,
the at least one memory and the computer code configured to, with the at least one processor, cause the multi-connectivity anchor node at least to
prepare a buffer status information; and
distribute the buffer status information to at least one of a plurality of schedulers.

2. The multi-connectivity anchor node according to claim 1, wherein the buffer status information is related to a user equipment.

3. The multi-connectivity anchor node according to claim 1, wherein the buffer status information comprises uplink buffer status information.

4. The multi-connectivity anchor node according to claim 1, wherein the at least one memory and the computer program code are further configured, with the at least one processor, to cause the multi-connectivity anchor node at least to
receive uplink buffer status information from a user equipment; and
determine the buffer status information based on the uplink buffer status information from the user equipment.

5. The multi-connectivity anchor node according to claim 1, wherein the buffer status information comprises downlink buffer status information.

6. The multi-connectivity anchor node according to claim 1, wherein the at least one memory and the computer program code are further configured, with the at least one processor, to cause the multi-connectivity anchor node at least to
receive downlink data, and
determine the buffer status information based on the downlink data.

7. The multi-connectivity anchor node according to claim 1, wherein the buffer status information is related to the at least one of the plurality of schedulers.

8. The multi-connectivity anchor node according to claim 1, wherein the buffer status information is regarding at least one of a plurality of legs of a split radio access flow and each of the at least one of a plurality of legs comprises a respective access node.

9. The multi-connectivity anchor node according to claim 1, wherein the buffer status information comprises an indication of at least one of no more or just a small amount of data to come, significant enough amount of data to come, or large amount of data to come.

10. An apparatus, comprising:
at least one processor; and
at least one memory including computer program code,
the at least one memory and the computer program code configured, with the at least one processor, to cause the apparatus at least to
receive, from a multi-connectivity anchor node, a buffer status information; and
schedule at least one user equipment based on the buffer status information.

11. The apparatus according to claim 10, wherein the at least one memory and the computer program code are further configured, with the at least one processor, to cause the apparatus at least to
receive downlink buffer status information related to a user equipment; and
determine downlink resource allocation for the user equipment based on the downlink buffer status information.

12. The apparatus according to claim 10, wherein the at least one memory and the computer program code are further configured, with the at least one processor, to cause the apparatus at least to
receive uplink buffer status information related to a user equipment; and
determine uplink resource allocation based on the uplink buffer status information.

13. The apparatus according to claim 12, wherein the at least one memory and the computer program code are further configured, with the at least one processor, to cause the apparatus at least to
determine the uplink resource allocation based on the buffer status information received from the multi-connectivity anchor node.

14. A method, comprising:
preparing, by a multi-connectivity anchor node, a buffer status information; and
distributing the buffer status information to at least one of a plurality of schedulers.

15. The method according to claim 14, wherein the buffer status information is related to a user equipment.

16. The method according to claim 14, further comprising:
receiving uplink buffer status information from a user equipment; and
determining the buffer status information based on the uplink buffer status information from the user equipment.

17. The method according to claim 14, further comprising:
receiving downlink data, and
determining the buffer status information based on the downlink data.

18. The method according to claim 14, wherein the buffer status information is related to the at least one of the plurality of schedulers.

19. The method according to claim 14, wherein the buffer status information is regarding at least one of a plurality of legs of a split radio access flow and each of the at least one of a plurality of legs comprises a respective access node.

20. The method according to claim 14, wherein the buffer status information comprises an indication of at least one of no more or just a small amount of data to come, significant enough amount of data to come, or large amount of data to come.
